(19) United States
(12) Patent Application Publication
(10) Pub. No.: US 2008/0256947 A1
(43) Pub. Date: Oct. 23, 2008

(54) System for Generating High Pressure Pulses

(75) Inventors: Bruno Walter, St. Albert (CA); Svatomira Walter, St. Albert (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: INDUSTRIAL SOUND TECHNOLOGIES INC., St. Albert, AB (CA)

(21) Appl. No.: 11/575,965

(22) PCT Filed: Sep. 27, 2005
(86) PCT No.: PCT/CA05/01477

§ 371 Date: Feb. 21, 2008

Related U.S. Application Data
(60) Provisional application No. 60/612,998, filed on Sep. 27, 2004.

(51) Int. Cl. F15B 21/12

(52) U.S. Cl. 60/532; 137/625

(57) ABSTRACT

A system (10) for generating high pressure pulses has a source (12, 16) of a pressurized working fluid (14). The working fluid is supplied to two conduits (22,24). A valve (26) has an input connected to each of the conduits (22, 24). The valve has a valve member (29) that is movable between two positions. In one position the valve member allows working fluid to flow from the first conduit (22) to an outlet and blocks the second conduit (24). In the other position the valve member allows working fluid to flow from the first conduit (22) to the outlet and blocks the first conduit (22). Flow of the working fluid causes the valve member to reciprocate and thereby generate water hammers in conduits (22) and (24). Energy from the water hammers may be harnessed for various applications.

### TECHNICAL FIELD

This invention relates to a hydraulic circuit for generating high pressure pulses. The circuit may be used to generate acoustic pulses for use, for example in the treatment of materials, pressure pulses for driving mechanical devices, or the like.

### BRIEF DESCRIPTION OF THE DRAWINGS

In the drawings which illustrate non-limiting embodiments of the invention:

FIG. 1 is a partially schematic diagram of a hydraulic circuit according to the invention for generating high pressure pulses in a fluid;

FIG. 2 is a detailed view of a valve portion of the circuit of FIG. 1 in a first position;

FIG. 3 is a detailed view of the valve portion of the circuit of FIG. 1 in a second position;

FIG. 4 is a partially schematic diagram illustrating an embodiment of the invention in which pressure pulses are used to drive the mechanical vibration of a rod;

FIG. 5 is a detailed view of a portion of the circuit shown in FIG. 4;

FIG. 6 is a top view of the components illustrated in FIG. 5;

FIG. 7 is a partially schematic view of an embodiment of the invention adapted to generate high intensity acoustic pulses; and,

FIG. 8 is a detailed view of a portion of the circuit of FIG. 7.

FIG. 9 is a detailed view of an alternative embodiment of the invention in which sonic pulses are amplified.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

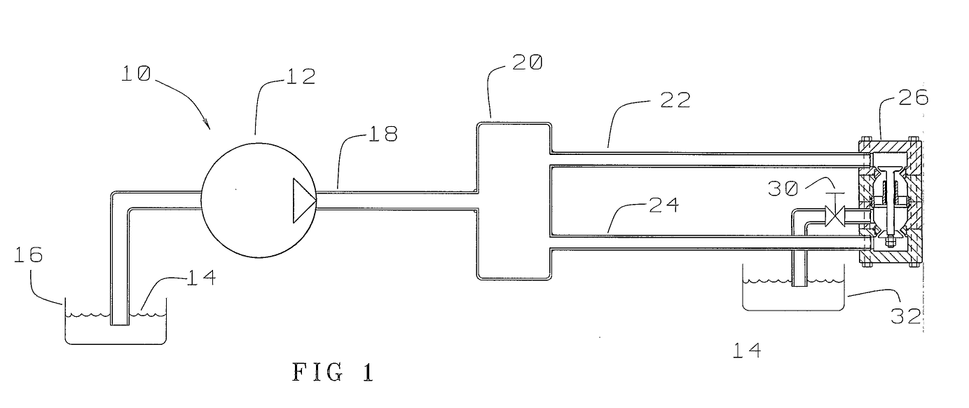

FIG. 1 shows a hydraulic circuit 10 according to the invention. Hydraulic circuit 10 includes a pump 12 which draws a fluid 14 from a reservoir 16 and pumps the fluid through a conduit 18 into a plenum 20. Fluid 14 is preferably a substantially non-compressible fluid such as water, oil, or the like. Plenum 20 is connected to a pair of parallel conduits 22 and 24. Both of conduits 22 and 24 are connected to different input ports of a valve 26. Fluid exiting from valve 26 passes out from an output port, through a throttle valve 30 and into a reservoir 32. Reservoir 16 and 32 may be the same reservoir.

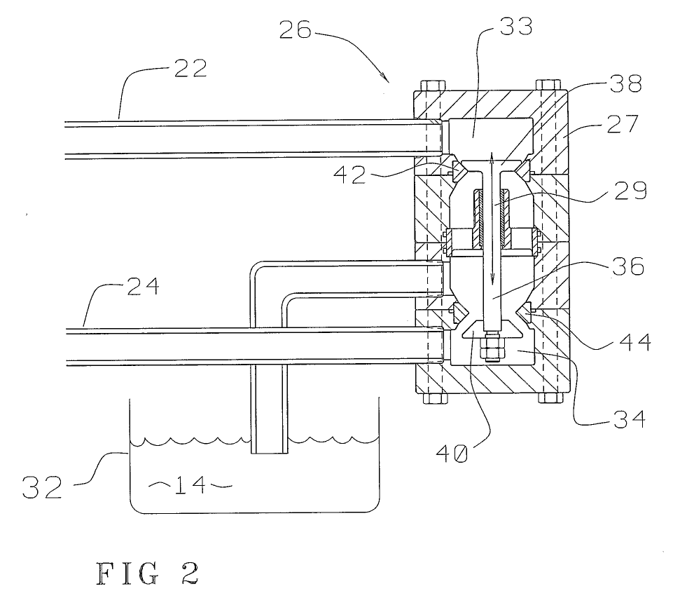

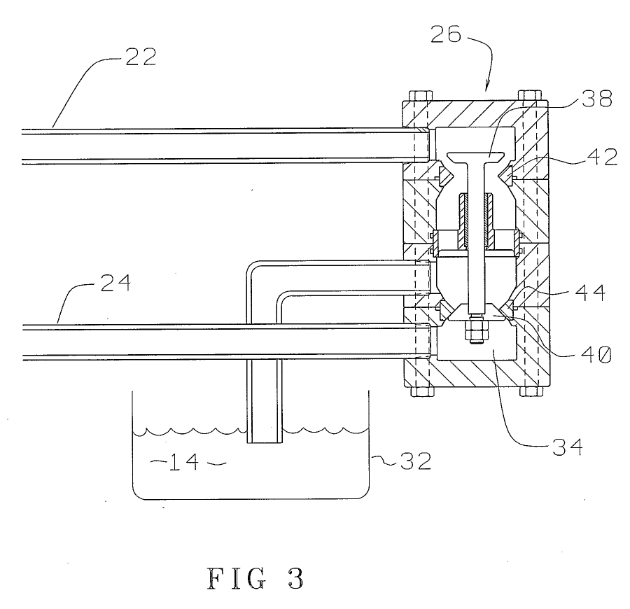

The construction of valve 26 is shown in detail in FIG. 2. Valve 26 includes a housing 27 which includes chambers 33 and 34 connected to conduits 22 and 24 respectively. Valve 26 has a movable valve member 36 which can reciprocate longitudinally as indicated by arrow 29. Valve member 36 has sealing members 38 and 40 in its ends. Sealing members 38 and 40 can seat against valve seats 42 and 44 respectively. Valve member 36 can move between a first position, as shown in FIG. 2, in which fluid in conduit 24 can flow through valve 26 to output conduit 28 (while sealing member 38 bears against valve seat 42 and thereby prevents fluid from conduit 22 from flowing to output conduit 28) and a second position, as shown in FIG. 3, wherein fluid from conduit 22 can flow through valve 26 to output conduit 28 while the flow of fluid from conduit 24 to output 28 is blocked by sealing member 40 (which seals against valve seat 44).

In operation, pump 12 pumps fluid from reservoir 16 through conduit 18 into plenum 20. The fluid is pressurized within plenum 20. Pump 12 does not need to be a high-pressure pump. Pump 12 may comprise, for example, a centrifugal pump. The pressure in plenum 20 causes the fluid 14 to flow down one or the other of conduits 22 and 24. Which one of conduits 22 and 24 the flow commences in depends upon the initial position of valve member 36. The fluid flows through valve 26 and out of conduit 28. Suppose, for example, that valve member 36 is initially in the position shown in FIG. 2. In this case, fluid will flow through conduit 24, through chamber 34, between sealing member 40 and valve seat 44, and out through conduit 28. In this event, the flow of fluid between valve member 40 and valve seat 44, will tend to drive valve member 36 towards the position shown in FIG. 3.

When sealing member 40 contacts valve seat 44 the flow of fluid through conduit 24 is suddenly cut off. This creates a “water hammer” within conduit 24. The water hammer creates a very high pressure pulse which propagates through conduit 24 from valve 26 toward reservoir 20. The water hammer phenomenon is well understood. Water hammer is explained in many textbooks on the topic of fluid mechanics. One example of such a textbook is Fluid Mechanics (7th Edition) Victor L. Streeter and E. Benjamin Wylie, McGraw-Hill Book Company, 1979 and R. L. Daugherty and J. B. Franzini, Fluid Mechanics With Engineering Applications, pages 425-431 McGraw Hill Book Company, 1977.

At the same time as valve member 36 moves so as to close sealing member 40 against valve seat 44, sealing member 38 moves away from valve seat 42. This permits fluid to flow from conduit 22 through valve 26 to outlet 28. In the meantime, the high pressure pulse which has been propagating upstream in conduit 24 eventually reaches plenum 20. At this point, some fluid from conduit 24 spills into plenum 20, and a corresponding low pressure pulse begins to propagate from plenum 20 toward valve 26 along conduit 24. When this low pressure pulse reaches chamber 34, it tends to draw valve member 36 back down into the position shown in FIG. 2. This tendency is augmented by the tendency of fluid flowing between sealing member 38 and valve seat 42 to move valve member 36 in the same direction.

The sudden closure of sealing member 38 against valve seat 42 causes a water hammer pulse to be propagated upstream in conduit 22. It can be appreciated that valve member 36 will reciprocate back and forth, alternately closing the fluid path from conduits 22 and 24. Each time valve member 36 allows such a fluid path to be opened and re-closed, a new water hammer pressure pulse is generated. The frequency with which these pressure pulses occur is determined primarily by the lengths of conduits 22 and 24, which are preferably equal in length.

In order to initiate the oscillation of valve member 36, it can be desirable to provide a throttle valve 30, as shown in FIG. 1. By throttling conduit 28 the pressure within a central portion 46 of valve 26 may be increased in a manner that promotes the onset of reciprocation of valve member 36.

Conduits 22 and 24 are preferably equal in length. The period of reciprocation of valve member 36 is determined, at least in part, by the lengths of conduits 22 and 24 (which determines the time that it takes for a pressure pulse to propagate upstream to plenum 20 and for a reflected negative pressure pulse to be propagated back downstream into chamber 33 or 34).

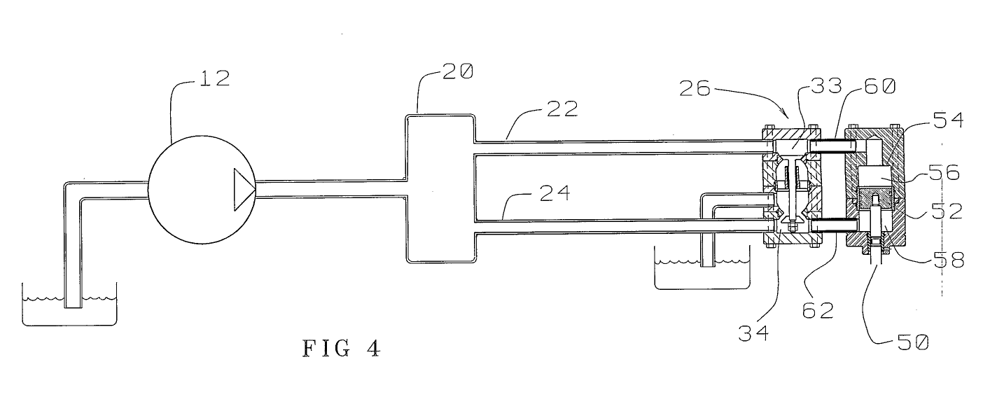

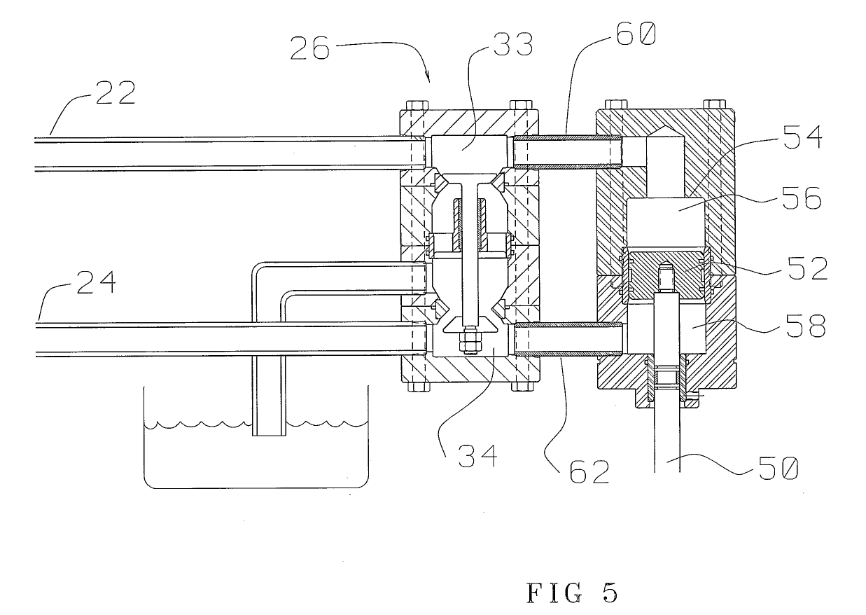

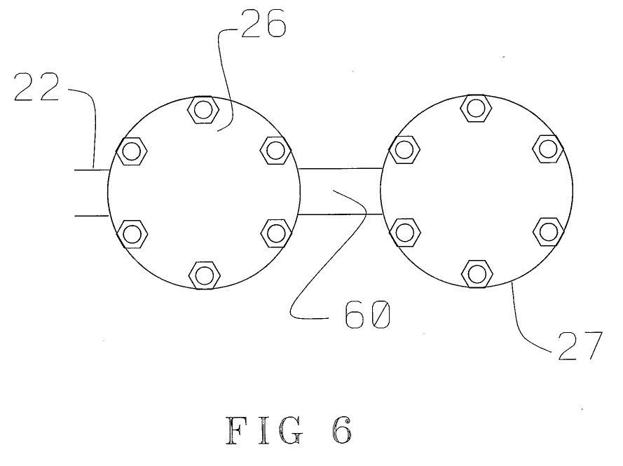

The high pressure pulses generated by circuit 10 may be utilized in various ways. FIG. 4 shows a circuit which uses such high pressure pulses for causing high intensity vibrations of a rod 50. As shown in more detail in FIGS. 5 and 6, rod 50 is connected to a piston 52 which is slidably disposed within a cylinder 54 within a housing 27. Piston 52 divides the volume within cylinder 54 into two portions, 56 and 58. Portion 56 is connected by means of a conduit 60 to volume 33 of valve 26. Portion 54 is connected by means of a conduit 62 to volume 34 of valve 26.

In operation, when a high pressure pulse is generated, commencing in volume 34 by the sudden closure of sealing member 40 against valve seat 44, the pressure within portion 58 of cylinder 54 is suddenly increased. This creates a very large upward acceleration on piston 52 which is transferred to rod 50. During this time the pressure within volume 33 and portion 56 is relatively low since fluid is flowing through volume 33. When valve member 36 moves so that sealing member 40 is away from valve seat 44 then the pressure within volume 34 and portion 58 is reduced. At the same time, a water hammer pressure pulse is generated within conduit 22. This pressure pulse is conveyed through conduit 60 into portion 56 and generates a sudden acceleration on piston 52 in the downward direction. It can be appreciated that as valve member 36 reciprocates then rod 50 is violently reciprocated at the frequency of motion of valve member 36. Rod 50 may be connected to deliver vibration or sonic energy to various mechanical structures. For example, rod 50 may be used to impart high acceleration vibrations to contacting members in a crusher for crushing rocks or other hard materials. Rod 50 may conduct vibrations into agitation paddles or other mechanical structures to be subjected to high intensity vibratory pulses.

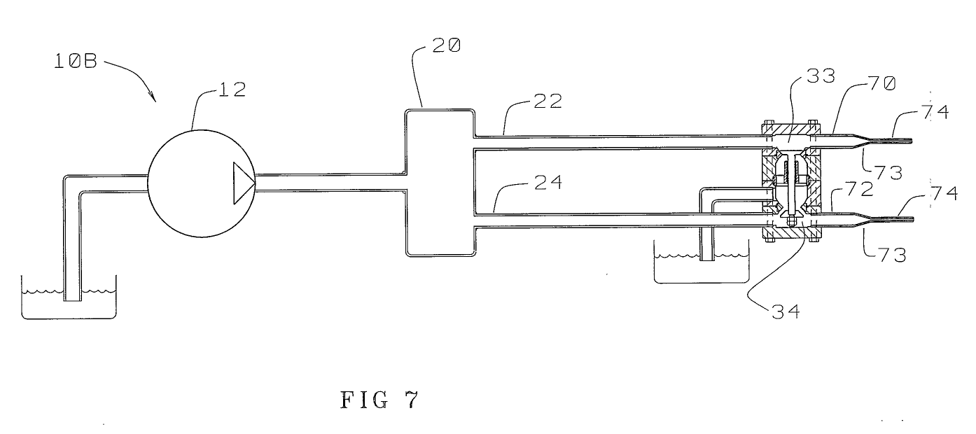

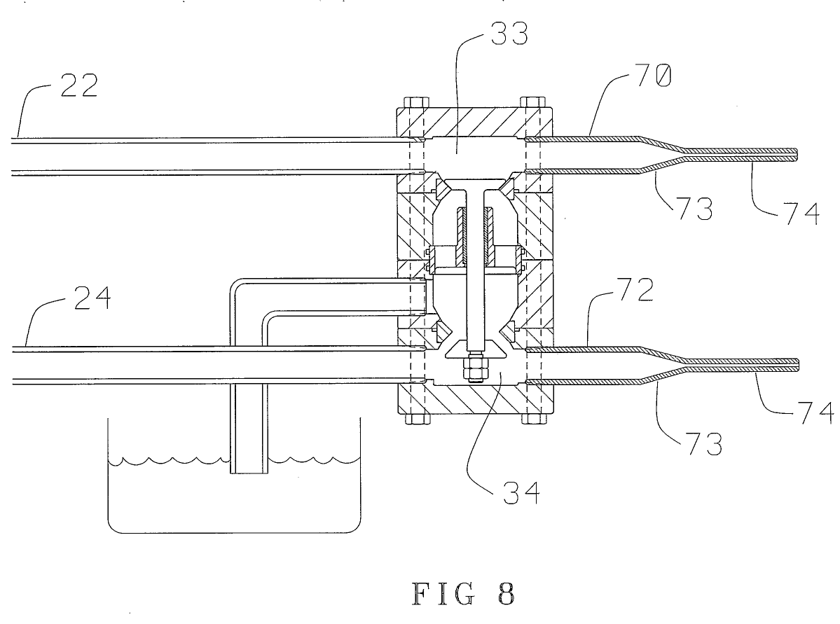

FIG. 7 discloses apparatus 10B according to an alternative embodiment of the invention in which chambers 33 and 34 are respectively connected to conduits 70 and 72 which include gradually tapering section 73. Gradually tapering sections 73 tend to increase the intensity of sonic pressure being carried through the fluid in conduits 70 and 72. Conduits 70 and 72 each terminate in a narrow diameter portion 74. In narrow diameter portion 74 the intensity of pressure pulses from chambers 33 and 34 are magnified. Portion 74 may be open-ended, as shown in FIG. 8, or may be closed-ended. Where portions 74 are open-ended, fluid will tend to flow out through conduits 70 and 72. The stream of fluid exiting through the ends of portions 74 will come out in spurts in time with the pressure pulses delivered from chambers 33 and 34. These high pressure spurts may be used in various applications. For example, they may be used in pressure washing, water jet cutting, or the like.

Fluid passing through conduits 70, 72 and 74 will be subjected to high shear conditions. Apparatus 10B can be used to alter the viscosity of fluid 14.

If portions 74 are closed-ended, then the ends of portions 74 will experience high energy oscillations, during and after the high pressure pulse. The frequency of such oscillations will depend on the length of portion 74. It has been experimentally determined that this causes a rapid rise in temperature of fluid in portions 74.

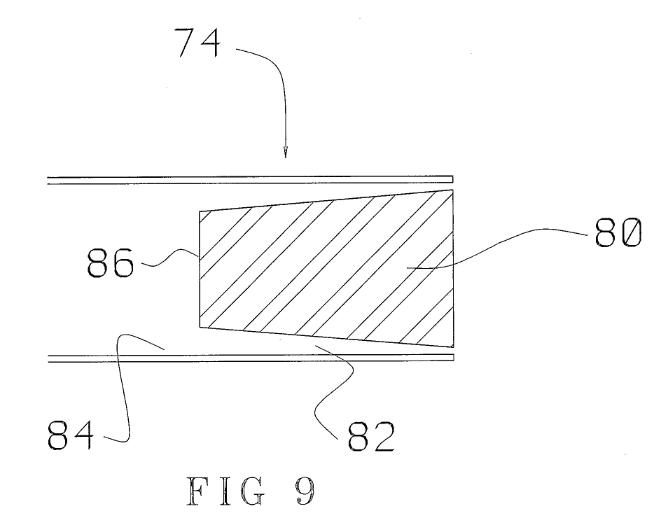

FIG. 9 illustrates an alternative construction of portions 74 in which each of conduits 70, 72 has its end partially blocked with a plug 80 (conduits 72 will typically be significantly longer than illustrated in FIG. 9). Narrow passages 82 extend between the plug and the inner walls 84 of tube 74. Fluid motivated by high pressure pulses can be driven through these narrow passages past plugs 80. Each plug 80 is gradually tapered and has an upstream-facing pointed end 86. The pressure of pressure pulses propagating in tubes 74 is amplified as the pressure pulses pass into the narrow passages surrounding plugs 80.

Various alternatives to these structures described above are possible. For example:
piston 52 could be replaced by a stiff diaphragm;
a second rod 50 could extend out of the top end of housing 27;
rod 50 could pass through both ends of housing 27. If so, rod 50 could be hollow. Where rod 50 is hollow, a mechanical member to be vibrated could pass through the bore of rod 50.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

1. An apparatus for generating high pressure pulses in a working fluid, the apparatus comprising:
(a) a source of pressurized working fluid;
(b) a first conduit communicating with the source;
(c) a second conduit communicating with the source; and
(d) a valve comprising a valve member moveable between a first position and a second position, the valve communicating with the first and second conduits wherein, in the first position, the valve member allows working fluid to flow from the first conduit to an outlet and blocks working fluid from flowing from the second conduit to the outlet, and wherein, in the second position, the valve member allows working fluid to flow from the second conduit to the outlet and blocks working fluid from flowing from the first conduit to the outlet.

2. An apparatus according to claim 1, wherein the valve member is driven from the first position to the second position at least in part by a flow of working fluid from the first conduit to the outlet and wherein the valve member is driven from the second position to the first position at least in part by a flow of working fluid from the second conduit to the outlet.

3. An apparatus according to claim 1, wherein the valve member comprises an elongated member that is reciprocable longitudinally between the first position and the second position.

4. An apparatus according to claim 3, wherein the valve member comprises a first sealing member and a second sealing member.

5. An apparatus according to claim 4, wherein the valve comprises a first valve seat and a second valve seat,
wherein, in the first position of the valve member, the second sealing member and second valve seat sealingly engage, and
wherein, in the second position of the valve member, the first sealing member and first valve seat sealingly engage.

6. An apparatus according to claim 1, wherein the first and second conduits are substantially equal in length.

7. An apparatus according to claim 1, wherein the working fluid is substantially non-compressible.

8. An apparatus according to claim 1, wherein the outlet is coupled to an output conduit.

9. An apparatus according to claim 8, comprising a throttle valve in the output conduit and downstream from the valve.

10. An apparatus according to claim 8, wherein the output conduit returns working fluid from the valve to the source of pressurized working fluid.

11. An apparatus according to claim 1, wherein the source of pressurized working fluid comprises:
(a) a reservoir;
(b) a pump communicating with the reservoir; and
(c) a plenum communicating with each of the pump, the first conduit and the second conduit.

12. An apparatus according to claim 1, wherein the valve comprises a first chamber through which the working fluid from the first conduit can flow to the outlet, and a second chamber through which the working fluid from the second conduit can flow to the outlet.

13. An apparatus according to claim 12, wherein the valve is coupled to a housing comprising:
(a) a moveable member that divides the housing into a first portion in communication with the first chamber and a second portion in communication with the second chamber; and
(b) at least one rod coupled to the moveable member,
wherein high pressure pulses created by the movement of the valve member between the first and second positions propagate to the first and second portions to cause a reciprocating motion of the rod.

14. An apparatus according to claim 13, wherein the housing comprises a cylinder.

15. An apparatus according to claim 14, wherein the moveable member comprises a piston.

16. An apparatus according to claim 14, wherein the moveable member comprises a diaphragm.

17. An apparatus according to claim 13, wherein the reciprocating motion of the rod conducts high acceleration vibrations to a mechanical member.

18. An apparatus according to claim 17, wherein the mechanical member is a contact member for a crusher for hard materials.

19. An apparatus according to claim 17, wherein the mechanical member is an agitation paddle.

20. An apparatus according to claim 12, wherein the first and second chambers each communicate with a respective secondary conduit, wherein each secondary conduit comprises a narrow downstream portion.

21. An apparatus according to claim 20, wherein the narrow downstream portion of at least one of the secondary conduits comprises an open end.

22. An apparatus according to claim 21, wherein the open ends expels high pressure pulses of working fluid.

23. An apparatus according to claim 20, comprising a tapered plug that partially blocks the flow of working fluid through the narrow downstream portion, wherein a passage between the plug and an inner wall of the narrow downstream portion gradually narrows in a downstream direction, amplifying pressure pulses of the working fluid flowing through the narrow downstream portion.

24. An apparatus according to claim 20, wherein the narrow downstream portion comprises a closed end.

25. An apparatus according to claim 24, wherein high pressure pulses of working fluid produced in the first and second chambers produce high energy oscillations of the narrow downstream portions.

26. A method for generating high pressure pulses, the method comprising:
(a) providing pressurized fluid to a first and second conduit;
(b) providing a valve connected to each of the first and second conduits; and
(c) operating the valve to allow the fluid to flow from the first and second conduit to an outlet in alternation.

27. A method according to claim 26, wherein operating the valve comprises reciprocating a valve member between a first position and a second position.

28. A method according to claim 27, comprising allowing the alternating fluid flow from the first and second conduits to the outlet to at least partly drive the reciprocation of the valve member between the first and second positions.

29. A method according to claim 26, comprising coupling to the valve a mechanical device driven by alternating pressure pulses.

30. A method according to claim 26, comprising providing a plurality of secondary conduits connected to the valve, wherein each secondary conduit comprises a narrow downstream portion.

31. A method according to claim 30, comprising amplifying pressure pulses in the fluid in the narrow down-stream portions.

32. A method according to claim 30, comprising altering the viscosity of the fluid in the narrow downstream portions.

33. A method according to claim 30, comprising expelling a stream of high pressure fluid from an open end of the narrow downstream portions.

34. A method according to claim 30, comprising raising the temperature of the fluid in the narrow down-stream portions.

35. A valve for use in generating high pressure pulses in a working fluid, the valve comprising a valve body having:
a first inlet;
a first inlet chamber communicating with the first inlet;
a second inlet;
a second inlet chamber communicating with the second inlet;
an outlet;
and a valve member moveable within the valve body between a first position wherein the first inlet communicates with the outlet and the second inlet is isolated from the outlet and a second position wherein the second inlet communicates with the outlet and the first inlet is isolated from the outlet;
wherein the valve member comprises a first head in the first inlet chamber;
a second head in the second inlet chamber; and
a rod disposed slidably in the valve body and connecting the first and second heads.

36. Apparatus comprising a valve according to claim 35;
a first conduit connected to deliver a working fluid under pressure to the first input; and
a second conduit connected to deliver a working fluid under pressure to the second input.

37.-38. (canceled)
